(19) United States
(12) Patent Application Publication
(10) Pub. No.: US 2005/0190320 A1
(43) Pub. Date: Sep. 1, 2005

(54) In-plane switching liquid crystal display device having extraordinary polarizers

(75) Inventor: Chiu-Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/066,977

(22) Filed: Feb. 25, 2005

(30) Foreign Application Priority Data
Feb. 27, 2004 (TW) 93105069

(51) Int. Cl. G02F 1/1335

(52) U.S. Cl. 349/96

(57) ABSTRACT

A liquid crystal display device (100) includes an upper substrate (12), a lower substrate (11), and a liquid crystal layer (130) interposed between the upper substrate and the lower substrate. An upper polarizer (143) and a lower polarizer (141) are positioned at the upper and lower substrates respectively, with at least one of the polarizers being an extraordinary type polarizer. A multiplicity of pixel electrodes (113) and common electrodes (111) are positioned at either the upper substrate or the lower substrate, for applying a voltage to the liquid crystal layer. The display device has a wide viewing angle, can work at high temperatures, and is relatively thin and compact.

### CROSS REFERENCE TO RELATED APPLICATIONS

This application is related to two co-pending applications both entitled “In-plane switching transflective liquid crystal display device,” and both being assigned to the same assignee as this application.

### BACKGROUND OF THE INVENTION

1. Field of the Invention

The present invention relates to liquid crystal displays, and more particularly to an in-plane switching liquid crystal display device having at least one extraordinary type polarizer.

2. Description of the Prior Art

The in-plane switching liquid crystal display (IPS-LCD) has been developed in order to improve on the narrow viewing angle of the more traditional twisted nematic liquid crystal display (TN-LCD). Typically, the IPS-LCD is a transmissive mode LCD, which utilizes a backlight for illuminating the display screen. The IPS-LCD comprises an upper substrate and a lower substrate disposed opposite to each other and spaced apart a predetermined distance. A liquid crystal layer having a multiplicity of liquid crystal molecules is disposed between the upper and lower substrates. A multiplicity of counter electrodes and a multiplicity of pixel electrodes are disposed on the lower substrate, with an insulating layer and an alignment film disposed on the counter and pixel electrodes in that order from bottom to top. The counter electrodes and pixel electrodes are all disposed on a same substrate of the opposite substrates, for driving the liquid crystal molecules. The resulting electric field is substantially planar and parallel to a surface of said same substrate. This configuration provides an improved viewing angle for the IPS-LCD.

A lower polarizer and an upper polarizer are positioned at outer surfaces of the lower and upper substrates, respectively. The lower and upper polarizers are ordinary type polarizers made of PVA (Polyvinyl Alcohol). Polarization axes of the upper polarizer and the lower polarizer are perpendicular to each other. A color filter and an alignment film are disposed on an undersurface of the upper substrate, in that order from top to bottom.

Because the polarizers are made of PVA, they cannot work at temperatures higher than 80 degrees Centigrade. This limits the kinds of application environments in which the IPS-LCD can be used. In addition, because the polarizers are both positioned as outer surfaces of the IPS-LCD, they are easily damaged or even destroyed in handling or in use. Furthermore, in manufacturing of the IPS-LCD, the polarizers are typically separate parts having protecting films. In the last step of manufacturing, the polarizers are adhered on the LCD panel. This makes the IPS-LCD unduly thick and bulky.

Moreover, the color filter layer has a de-polarizing effect on light beams passing therethrough, due to pigment light scattering. That is, light beams passing through the IPS-LCD are partially de-polarized by the color filter layer before reaching the upper polarizer. This de-polarizing of the light beams can reduce the contrast ratio of the IPS-LCD. Even though such de-polarizing effects are generally small, they can have a significant effect on the contrast ratio of the IPS-LCD.

It is desired to provide an in-plane switching liquid crystal display which overcomes the above-described deficiencies.

### SUMMARY OF THE INVENTION

Accordingly, an object of the present invention is to provide a liquid crystal display device which has a wide view angle, which can work at high temperatures, and which is relatively thin and compact.

Another object of the present invention is to provide a liquid crystal display device which achieves a good contrast ratio over wide viewing angles.

To achieve the above objects, a liquid crystal display device in accordance with the present invention comprises an upper substrate, a lower substrate, and a liquid crystal layer interposed between the upper substrate and the lower substrate. An upper polarizer and a lower polarizer are positioned at the upper and lower substrate respectively, with at least one of the polarizers being an extraordinary type polarizer. A multiplicity of pixel electrodes and common electrodes are positioned at either the upper substrate or the lower substrate, for applying a voltage to the liquid crystal layer.

Other objects, advantages and novel features of the present invention will be apparent from the following detailed description of exemplary embodiments thereof with reference to the attached drawings, in which:

### BRIEF DESCRIPTION OF THE DRAWINGS

FIG. 1 is a schematic, side cross-sectional view of part of an IPS-LCD according to a first embodiment of the present invention;

FIG. 2 is a schematic, side cross-sectional view of part of an IPS-LCD according to a second embodiment of the present invention; and

FIG. 3 is a schematic, side cross-sectional view of part of an IPS-LCD according to a third embodiment of the present invention.

### DETAILED DESCRIPTION OF THE EXEMPLARY EMBODIMENTS

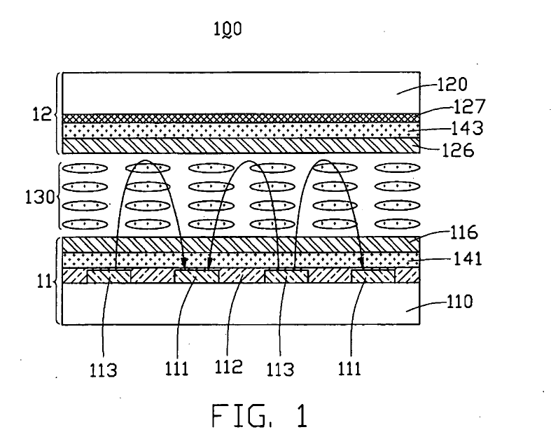

Referring to FIG. 1, a liquid crystal display device 100 of the first embodiment (“Example 1”) according to the present invention includes an upper substrate 12, a lower substrate 11, and a liquid crystal layer 130 interposed between the upper substrate 12 and the lower substrate 11. The upper substrate 12 comprises a color filter layer 127, an upper polarizer 143 and an upper alignment film 126 positioned in that order from top to bottom on an inner surface of an upper glass plate 120. The lower substrate 11 comprises a multiplicity of pairs of a pixel electrode 113 and a common electrode 111, an insulating layer 112, a lower polarizer 141 and a lower alignment film 116 positioned in that order from bottom to top on an inner surface of a lower glass plate 110. The lower substrate 11 may comprise a thin film transistor (TFT) array (not shown) connecting with the pixel electrodes 113. In an alternative embodiment, the upper glass plate 120 and the lower glass plate 110 can be made of silicon dioxide (SiO₂) instead.

The pixel electrodes 113 and the common electrodes 111 are made of a transparent conductor. A material of the transparent conductor can, for example, be indium tin oxide (ITO) or indium zinc oxide (IZO). The upper and lower alignment films 126, 116 are alignment layers for orientating liquid crystal molecules in the liquid crystal layer 130. The color filter layer 127 comprises a black matrix (not shown), and a color resin layer having Red, Green and Blue segments. The black matrix is disposed between segments of the color resin layer, to prevent light beams from leaking.

The upper and lower polarizers 143, 141 both are extraordinary type polarizers composed of mixtures of narrow-band components. Each narrow-band component comprises a modified organic dye material which exists in a liquid-crystalline phase. Polarizing axes of the polarizers 143, 141 are perpendicular to each other; that is, the polarizers 143, 141 are crossed polarizers. The polarizers 143, 141 pass extraordinary polarized light beams, while blocking ordinary polarized light beams. The polarizers 143, 141 are insulative, and each has a thickness of less than 100 microns. This ensures that the operating voltage of the liquid crystal display device 100 is not affected by the polarizers 143, 141 being formed at inner surfaces of the upper substrate 12 and the lower substrate 11 respectively. In an alternative embodiment, the upper polarizer 143 can be an ordinary type polarizer.

In operation, when no voltage is applied between the pixel and common electrodes 113 and 111, long axes of the liquid crystal molecules in the liquid crystal layer 130 maintain a predetermined angle relative to the upper alignment film 126 and the lower alignment film 116, and the liquid crystal molecules are stationed parallel to the upper and lower substrates 12 and 11.

When a voltage is applied (in the driven state), an electric field (not labeled) is generated between the pixel and common electrodes 113, 111. Because the pixel electrodes 113 and the common electrodes 111 are at the same substrate (and at the same layer as seen in FIG. 1), the electric field is substantially parallel to the upper and lower substrates 12, 11. The substantially parallel electric field drives the liquid crystal molecules of the liquid crystal layer 130 to rotate so they have a new orientation that is still parallel to the upper and lower substrates 12 and 11. The change in orientation results in a change in light transmission, and the displayed image has the important advantage of a wide viewing angle.

The liquid crystal display device 100 of Example 1 has the polarizers 143, 141 positioned within the liquid crystal cell thereof. At least one of the polarizers 143, 141 is an extraordinary type polarizer, and each of the polarizers 143, 141 has a thickness of less than 100 microns. Thus the liquid crystal display device 100 resists damage that might occur because of contamination or foreign matter, and is thin and compact. In addition, the liquid crystal display device 100 is ideal for use in a touch LCD panel, because only a touch layer needs to be positioned thereon. Furthermore, the polarizers 143, 141 are made of a modified organic dye material which exists in a liquid-crystalline phase. Therefore the liquid crystal display device 100 can work at temperatures up to 200 degrees Centigrade, and have a broader range of applications in the LCD marketplace.

Moreover, the color filter layer 127 is positioned on the upper substrate 120 above the upper polarizer 143. Optical beams from a back light module (not shown) reach the color filter layer 127 after passing through the upper polarizer 143. This arrangement reduces or eliminates the adverse effects of color filter de-polarizing, and yields a higher contrast ratio.

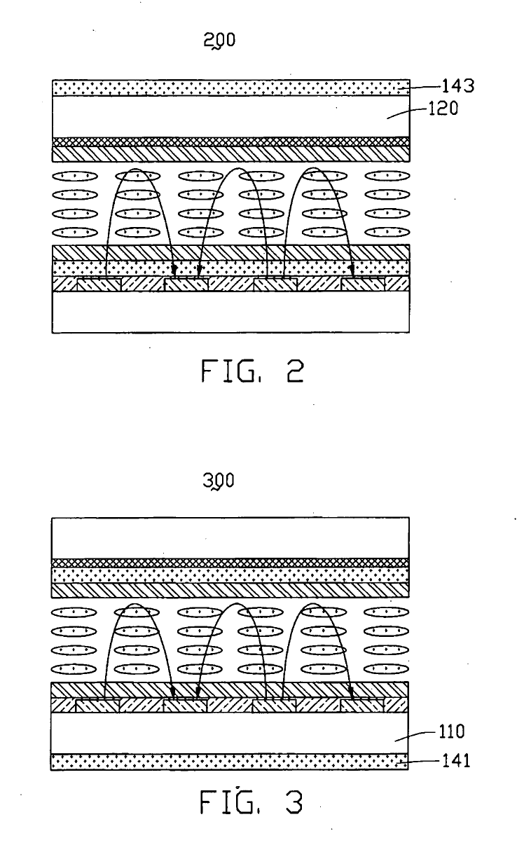

Referring to FIGS. 2 and 3, these respectively show a liquid crystal display device 200 of the second embodiment (“Example 2”) and a liquid crystal display device 300 of the third embodiment (“Example 2”) according to the present invention. Examples 2 and 3 are variations of Example 1. In Example 2, the upper polarizer 143 is positioned on an outer surface of the upper glass plate 120. In Example 3, the lower polarizer 141 is positioned on an outer surface of the lower glass plate 110.

It is to be understood, however, that even though numerous characteristics and advantages of the present invention have been set out in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A liquid crystal display device comprising:
an upper substrate;
a lower substrate;
a liquid crystal layer interposed between the upper substrate and the lower substrate;
an upper polarizer and a lower polarizer positioned at the upper and lower substrates respectively, with at least one of the polarizers being an extraordinary type polarizer; and
a plurality of pixel electrodes and common electrodes positioned at either the upper substrate or the lower substrate, for applying a voltage to the liquid crystal layer.

2. The liquid crystal display as claimed in claim 1, wherein both of the upper and lower polarizers are extraordinary type polarizers.

3. The liquid crystal display as claimed in claim 2, wherein each of the polarizers has a thickness of less than 100 microns.

4. The liquid crystal display as claimed in claim 2, wherein each of the polarizers is made of a modified organic dye material which exists in a liquid crystalline phase.

5. The liquid crystal display as claimed in claim 1, wherein the upper polarizer is an ordinary type polarizer.

6. The liquid crystal display as claimed in claim 1, wherein polarizing axes of the upper and lower polarizers are perpendicular to each other.

7. The liquid crystal display as claimed in claim 1, wherein the pixel electrodes and the common electrodes are made of indium tin oxide and/or indium zinc oxide.

8. The liquid crystal display device as claimed in claim 1, wherein the upper substrate comprises in turn a glass plate, a color filter, the upper polarizer and an alignment film, and the lower substrate comprises in turn a glass plate, the common and pixel electrodes, an insulating layer, the lower polarizer and an alignment film.

9. The liquid crystal display device as claimed in claim 1, wherein the upper substrate comprises in turn the upper polarizer, a glass plate, a color filter, and an alignment film, and the lower substrate comprises in turn a glass plate, the common and pixel electrodes, an insulating layer, the lower polarizer and an alignment film.

10. The liquid crystal display device as claimed in claim 1, wherein the upper substrate comprises in turn a glass plate, a color filter, the upper polarizer and an alignment film, and the lower substrate comprises in turn the lower polarizer, a glass plate, the common and pixel electrodes, an insulating layer, and an alignment film.

11. The liquid crystal display device as claimed in claim 1, wherein the pixel electrodes and the common electrodes are positioned on a same layer at the lower substrate.

12. The liquid crystal display device as claimed in claim 1, wherein the pixel electrodes and the common electrodes are positioned on different layers at the lower substrate.

13. A liquid crystal display device comprising:
an upper substrate;
a lower substrate;
a liquid crystal layer interposed between the upper substrate and the lower substrate;
an upper polarizer and a lower polarizer positioned at the upper and lower substrates respectively, with at least one of the polarizers positioned at an inside of the applicable upper substrate and lower substrate; and
a plurality of pixel electrodes and common electrodes positioned at either the upper substrate or the lower substrate.

14. The liquid crystal display as claimed in claim 13, wherein both of the upper and lower polarizers are extraordinary type polarizers.

15. The liquid crystal display as claimed in claim 14, wherein each of the polarizers has a thickness of less than 100 microns.

16. The liquid crystal display as claimed in claim 14, wherein polarizing axes of the upper polarizer and the lower polarizer are perpendicular to each other.

17. The liquid crystal display as claimed in claim 14, wherein each of the upper and lower polarizers is made of a modified organic dye material which exists in a liquid crystalline phase.

18. The liquid crystal display device as claimed in claim 13, wherein the pixel electrodes and the common electrodes are positioned on a same layer at the lower substrate.

19. The liquid crystal display device as claimed in claim 13, wherein the pixel electrodes and the common electrodes are positioned on different layers at the lower substrate.

20. A liquid crystal display device comprising:
a first substrate;
a second substrate;
a liquid crystal layer interposed between the first substrate and the second substrate;
an alignment film disposed between the liquid crystal layer and one of said first and second substrates; and
a polarizer disposed between the alignment film and said one of the first and second substrates; wherein
said polarizer is an extraordinary type polarizer.
